(19) United States
(12) Patent Application Publication
(10) Pub. No.: US 2005/0141502 A1
(43) Pub. Date: Jun. 30, 2005

(54) Method and apparatus to provide multicast support on a network device

(76) Inventors: Alok Kumar, Santa Clara, CA (US); Prashant R. Chandra, Sunnyvale, CA (US); Uday R. Naik, Fremont, CA (US)

Correspondence Address: Anthony H. Azure;BLAKELY, SOKOLOFF, TAYLOR & ZAFMAN LLP, Seventh Floor, 12400 Wilshire Boulevard, Los Angeles, CA, 90025, US

(21) Appl. No.: 10/748,429

(22) Filed: Dec. 30, 2003

(51) Int. Cl. H04L 12/56

(52) U.S. Cl. 370/390; 370/432

(57) ABSTRACT

A method and apparatus to provide multicast support on a network device. The network device receives an incoming multicast packet, the multicast packet comprising an incoming multicast header and packet data. The packet data is stored at the network device. A plurality of outgoing multicast headers are generated based on the incoming multicast header. Each outgoing multicast header of the plurality of outgoing multicast headers is attached to the packet data to create a plurality of outgoing multicast packets without making multiple copies of the packet data.

### BACKGROUND

1. Field of Invention

The field of invention relates generally to network devices and, more specifically but not exclusively, relates to multicast support on a network device.

2. Background Information

Networks provide the infrastructure for many forms of communication. LANs (Local Area Network), WANs (Wide Area Network), MANs (Metropolitan Area Network), and the Internet are common networks. Packets sent on networks are often handled by various network devices such as bridges, hubs, switches, and routers.

Transmissions may be sent on networks using a variety of methods. These methods include unicasts, broadcasts, and multicasts. A unicast involves the communication from one device to another device over a network. If sending a unicast transmission to multiple recipients, then one copy of a packet is sent to each receiver. However, sending a unicast to multiple recipients wastes network resources and is extremely cumbersome on a large scale. A broadcast involves sending one copy of each packet addressed to a broadcast address on a network. Broadcasting wastes network bandwidth if only a sub-group of the network needs to receive the transmission.

A multicast usually involves sending one copy of each packet and addressing the packet to the group of hosts that want to receive the packet. Multicast packets are addressed to a group of recipients called a multicast group. The packets are forwarded only to the networks having hosts that are members of the multicast group. All members of a multicast group share the same multicast address. In multicast, the sender may not know the unicast network address of the particular recipients of the multicast transmission.

Multicast transmissions may be used with various networks, includes LAN's, WAN's and the Internet. Multicast reduces the amount of network traffic that would be created by a broadcast or multiple unicasts. Examples of multicast applications include audio and video streaming, instant messaging, and distribution of software and news.

Generally, multicast routing protocols are categorized as either Dense Mode or Sparse Mode depending on how the protocol computes a distribution tree. In a Dense Mode multicast routing protocol, distribution trees are built by initially flooding a network with multicast traffic and then pruning out paths that do not lead to the multicast group. In a sparse mode multicast routing protocol, the hosts are usually widely dispersed, such as on the Internet. The distribution tree of a sparse mode protocol is initially empty and built as requests are made by network devices to join the multicast group.

In multicasting, the same packet data is sent to multiple recipients within the multicast group. Paths leading to these recipients may be along different paths from a network device. Network devices forwarding multicast packets often copy the same packet data before forwarding the multicast packets from different output ports. Separate copies of the packet data are created and stored in memory of the network device. Making multiple copies of the same packet data creates a memory bandwidth bottleneck and wastes the resources of the network device. Also, some network devices that are capable of forwarding multicast packets suffer degradation in managing unicast transmissions. Further, modifying existing network devices to handle multicast transmissions can be cost prohibitive.

### BRIEF DESCRIPTION OF THE DRAWINGS

The present invention is illustrated by way of example and not by limitation in the accompanying figures.

FIG. 1 is a schematic diagram illustrating one embodiment of a network for multicasting in accordance with the teachings of the present invention.

FIG. 2 is a schematic diagram illustrating one embodiment of a router to provide multicast support on a network device in accordance with the teachings of the present invention.

FIG. 2B is a schematic diagram illustrating embodiments of an incoming multicast packet and an outgoing multicast packet in accordance with the teachings of the present invention.

FIG. 3 is a schematic diagram illustrating one embodiment to provide multicast support on a network device in accordance with the teachings of the present invention.

FIG. 4 is a flowchart illustrating one embodiment of the logic and operations to provide multicast support on a network device in accordance with the teachings of the present invention.

FIG. 5 is a schematic diagram illustrating one embodiment of a network device in accordance with the teachings of the present invention.

### DETAILED DESCRIPTION

Embodiments of a method and system to provide multicast support on a network device are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

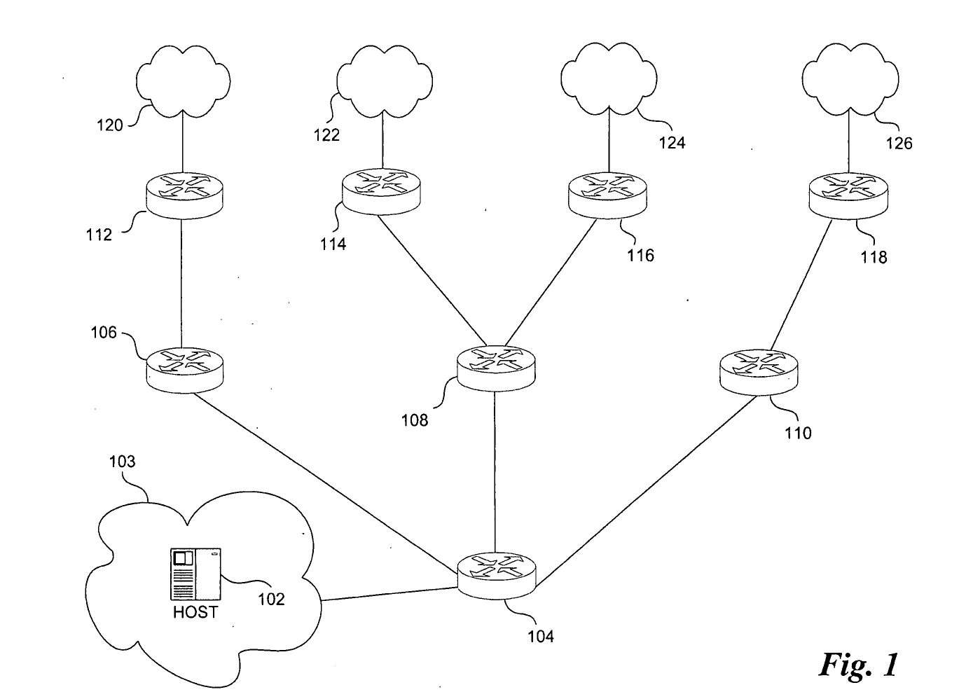

Referring to FIG. 1, a schematic diagram illustrating one embodiment of a network is shown. FIG. 1 shows a spanning tree for a multicast transmission. A network 103 is communicatively coupled to a router 104. Network 103 includes a host 102 that is part of a multicast group. Routers 106, 108, and 110 are communicatively coupled to router 104. Router 106 is communicatively coupled to router 112. Router 108 is communicatively coupled to routers 114 and 116. Router 110 is communicatively coupled to router 118. Routers 112, 114, 116, and 118 are communicatively coupled to networks 120, 122, 124, and 126, respectively. Each of networks 120, 122, 124, and 126 include hosts (not shown) that are also part of the multicast group. Networks 103, 120, 122, 124, and 126 include, but are not limited to, LANs, WANs, MANs, or the like, or any combination thereof. In one embodiment, the multicast group uses dynamic registration as hosts join and leave the multicast group. It should be appreciated that the embodiment shown in FIG. 1 may be scaled to include any number of routers coupled in various different communication paths.

A first router, router 104, computes a spanning tree that includes other routers having hosts that are part of the multicast group. The router 104 prunes out paths that do not lead to routers having hosts of the multicast group. Subsequently, multicast packets are forwarded only along the remaining paths to the hosts of the multicast group. FIG. 1 shows only routers that lead to hosts that are part of the multicast group.

Generally, router 104 will forward a copy of the multicast packet to routers 106, 108, and 110. Router 104 makes three copies of the packet data internally before forwarding a multicast packet out of three different output ports of router 104. The router 104 creates three separate copies of the packet data and stores these copies in memory, such as Dynamic Random Access Memory (DRAM). Creating and storing multiple copies slows packet processing by router 104 because of the limits of memory bandwidth. Also, since router 108 must forward a multicast packet to routers 114 and 116, router 108 internally makes two copies of the multicast packet data in memory to send a multicast packet from two different output ports. Embodiments of the present invention provide methods to forward multicast packets without making multiple copies of the multicast packet data in memory of a network device.

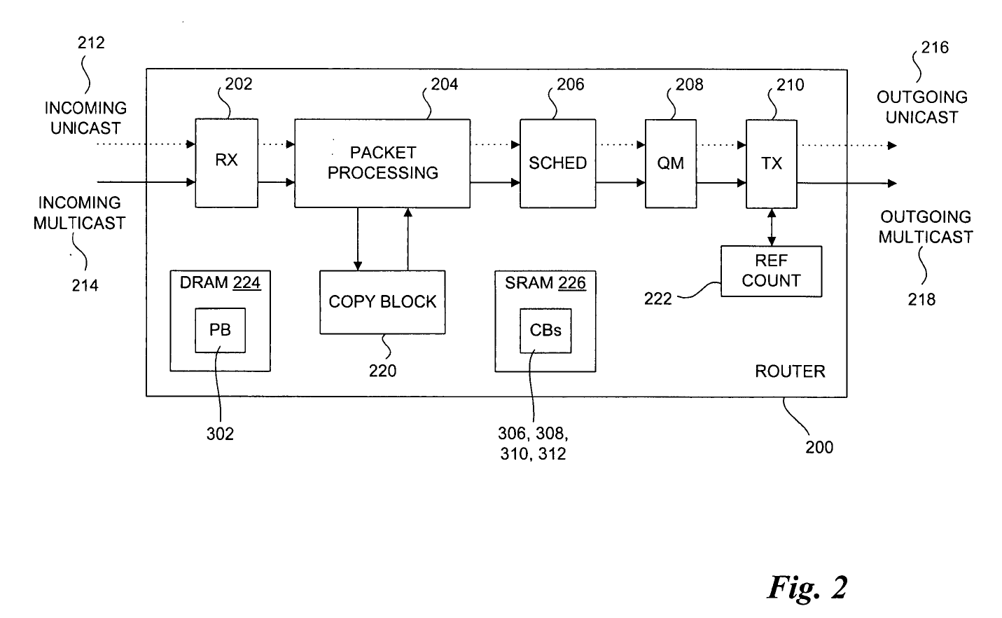

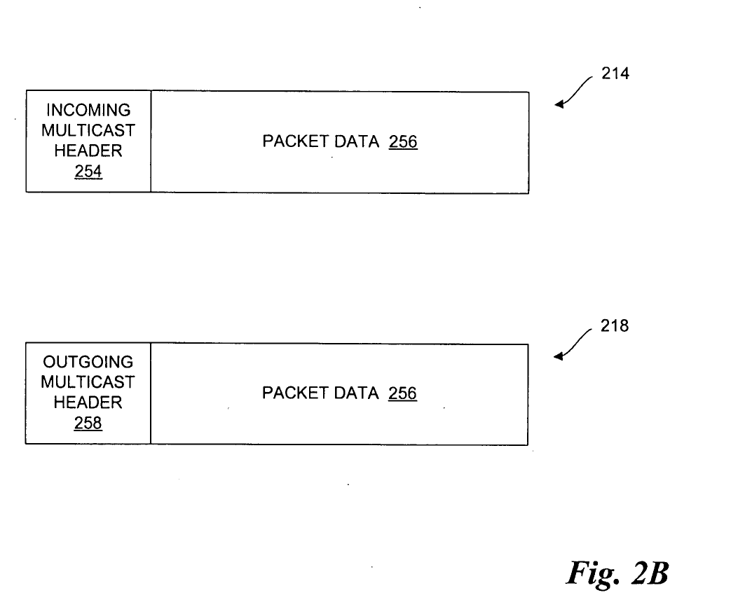

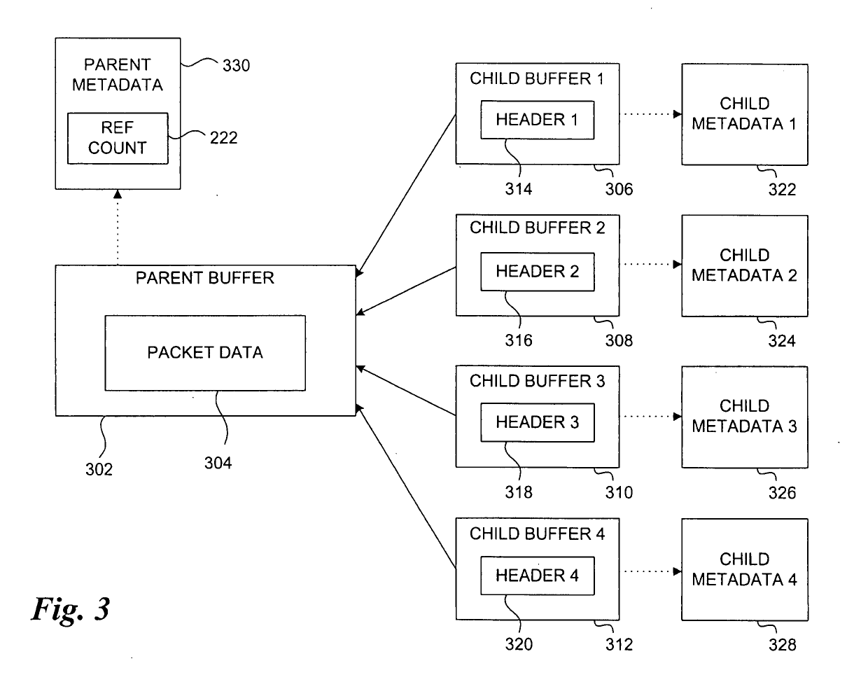

Referring to FIGS. 2 and 3, an embodiment to provide multicast support on a network device will be discussed. While the FIGS. 2 and 3 are described in terms of a router, it will be understood that embodiments of the invention are not limited to a router and include other network devices such as, but not limited to, bridges, hubs, and switches. Also, it will be understood that the functional blocks described in FIGS. 2 and 3 may be implemented in software, hardware, or a combination of hardware and software. Router 200 may also include other functional blocks that are not shown for the sake of clarity.

Embodiments of the present invention are described as protocol independent. Embodiments may operate with dense-mode and sparse-mode multicast protocols. Embodiments of the present invention may support OSI (Open Standards Interconnection) Layer 2 and Layer 3 multicast protocols. Multicast protocols that may employ embodiments of the present invention include, but are not limited to, IP (Internet Protocol) multicast, DVMRP (Distance Vector Multicast Routing Protocol), PIM-DM (Protocol Independent Multicast-Dense Mode), MOSPF (Multicast extensions for Open Shortest Path First), PIM-SM (Protocol Independent Multicast-Sparse Mode), CBT (Core Based Trees), or the like.

Router 200 receives an incoming unicast packet 212 as well as an incoming multicast packet 214. Router 200 also forwards outgoing unicast packet 216 and outgoing multicast packet 218. Referring to FIG. 2B, embodiments of an incoming multicast packet 214 and outgoing multicast packet 218 are shown. The incoming multicast packet 214 includes an incoming multicast header 254 and packet data 256. The outgoing multicast packet 218 includes an outgoing multicast header 258 and packet data 256. It will be understood that embodiments of incoming unicast packet 212 and outgoing unicast packet 216 also include a header and packet data.

Referring again to FIG. 2, a receiver 202 is coupled to a packet processing unit 204 to receive incoming unicast packet 212 and incoming multicast packet 214. The packet processing unit 204 manages unicast and multicast packets passing through the router. The packet processing unit 204 is coupled to a scheduler 206 to schedule the flow of packets transmitted from the router. In one embodiment, packets are transmitted from the router 200 based on a first-in, first-out (FIFO) logic basis. The scheduler 206 is coupled to a queue manager 208 that is coupled to a transmitter 210. The queue manager 208 manages packets that are ready to be forwarded by the router. In one embodiment, the queue manager 208 includes a linked list of pointers that indicate the location of packets in memory that are ready to be transmitted. The transmitter 210 transmits outgoing unicast packet 216 and outgoing multicast packet 218.

Referring to FIGS. 2 and 3, a parent buffer (PB) 302 stores the packet data 304 received by router 200. In one embodiment, the receiver 202 manages parent buffer 302. In another embodiment, the parent buffer 302 is maintained in Dynamic Random Access Memory (DRAM) 224 of router 200.

The parent buffer 302 has associated with it a parent metadata 330. The parent metadata includes a description of the content of the parent buffer 302. In one embodiment, the parent metadata 330 also includes a reference count 222. The reference count 222 indicates the number of outgoing multicast headers remaining that have not been used-to construct an outgoing multicast packet. In one embodiment, the reference count 222 indicates the number of child buffers pointing to the parent buffer 302 (discussed further below.)

In one embodiment, the transmitter 210 manages the reference count 222. The reference count 222 will be decremented by the transmitter 210 after a multicast packet is transmitted. In one embodiment, the transmitter 210 will read the reference count from the parent metadata and update the reference count field of the parent metadata after a multicast packet is transmitted.

FIGS. 2 and 3 shows four child buffers (CBs) 306, 308, 310, and 312, to store four outgoing multicast headers for a multicast transmission. Each child buffer contains an outgoing multicast header to be used in a multicast packet to be sent from different output interfaces of router 200. A child buffer is created for each output port from the router 200 that leads to a member of the multicast group. While the embodiment of FIGS. 2 and 3 shows four child buffers corresponding to four headers, it will be understood that embodiments of the invention may include other numbers of child buffers and headers. Child buffers 306, 308, 310, and 312 store outgoing multicast headers 314, 316, 318, and 320, respectively. Each child buffer points to the parent buffer 302.

Child metadata 322, 324, 326, and 328 is associated with the child buffers 306, 308, 310, and 312, respectively. The child metadata includes a description of the content of its associated child buffer. One embodiment of the parent metadata and child metadata is shown below in Table 1. In one embodiment, the child buffers 306, 308, 310, and 312 and their child metadata 322, 324, 326, and 328 are stored in Static Random Access Memory (SRAM) 226 of router 200.

Router 200 also includes a copy block 220 coupled to the packet processing unit 204. When the packet processing unit 204 receives a multicast transmission, the copy block 220 creates the child buffers and corresponding child metadata for the outgoing multicast packets. The copy block 220 also generates the outgoing multicast headers 314, 316, 318, 320 based on the incoming multicast header of the incoming multicast packet. The copy block 220 loads the outgoing multicast headers into respective child buffers.

In one embodiment, the copy block 220 is implemented as a separate micro-engine in router 200. This allows the router 200 to service various multicast protocols because the copy block 220 is independent of the multicast protocol. Having a separate copy block 220 also simplifies the ability for the packet processing unit 204 to process unicast and multicast packets similarly (discussed further below.)

TABLE 1

| Child Metadata | | | Parent Metadata | | |
|---|---|---|---|---|---|
| | Size in | | | Size in | |
| Word# | bits | Description | Word# | bits | Description |
| 0 | 32 | Hw_next (for child | 0 | 32 | Hw_next (for child this |
| | | this is a pointer | | | is a pointer to the |
| | | to the parent | | | parent buffer pointer) |
| | | buffer pointer) | | | |
| 1 | 16 | Buffer size | 1 | 16 | Buffer size |
| 1 | 16 | Offset | 1 | 16 | Offset |
| 2 | 16 | Packet size (for | 2 | 16 | Packet size (for child, |
| | | child, this is | | | this is parent's buffer |
| | | parent's buffer offset) | | | offset) |
| 2 | 16 | Buffer info (4 | 2 | 16 | Buffer info (4 bits |
| | | bits free list id, | | | free list id, 4 bits |
| | | 4 bits rx_stat, 8 | | | rx_stat, 8 bit header |
| | | bit header type) | | | type) rx_stat contains |
| | | rx_stat contains | | | bits for fragmented and |
| | | bits for fragmented | | | multicast packets. Also |
| | | and multicast | | | contains a bit for |
| | | packets | | | single buffer ref_cnt) |
| 3 | 16 | Input port | 3 | 16 | Input port |
| 3 | 16 | Output port | 3 | 16 | Output port |
| 4 | 16 | Next hop id | 4 | 16 | Next hop id |
| 4 | 8 | Fabric port | 4 | 8 | Fabric port |
| 4 | 8 | Reserved | 4 | 8 | Reserved |
| 5 | 32 | Flow id and color | 5 | 32 | Flow id and color (top |
| | | (top 4 bits is | | | 4 bits is color and |
| | | color and bottom 28 | | | bottom 28 bits is flow |
| | | bits is flow id) | | | id) |
| 6 | 16 | Class id | 6 | 16 | Class id |
| 6 | 16 | Reserved | 6 | 16 | Reserved |
| 7 | 32 | Packet Next | 7 | 32 | Packet Next (In parent |
| | | | | | meta data this is the |
| | | | | | ref count field) |

In one embodiment, the format of metadata for unicast transmissions and the format of metadata for multicast transmissions are the same. Every buffer (parent and child) has an associated metadata in order to maintain consistency with unicast packets passing through the same network device. In a unicast transmission, the unicast packet data and the unicast header will be maintained in a parent buffer having a corresponding unicast parent metadata. Embodiments of the present invention extend the idea of metadata from unicast transmissions to multicast transmissions. Thus, a multicast packet can be processed along the same processing pipeline as a unicast packet.

It will be understood that apart from the actual multicast forwarding block of router 200, the other packet processing blocks do not need to distinguish between multicast and unicast traffic. These other processing blocks simply modify the packet metadata. Embodiments of the invention allow an application to present an identical metadata interface to these packet processing blocks for both unicast and multicast traffic.

The child metadata may be used by other functional blocks of the router 200, such as the queue manage 208 for queuing of a multicast packet. The child buffer of a multicast packet should not appear different to the network device than a parent buffer for a unicast packet. By providing child metadata fields similar to parent metadata fields, the functional blocks of the router can process unicast and multicast packets similarly. As shown in FIG. 2, incoming unicast packet 212 and incoming multicast packet 214 pass through the same processing pipeline and exit the router 200 as outgoing unicast packet 216 and outgoing multicast packet 218. The multicast pipeline includes the copy block 220 to implement the multicast support scheme as described herein. Thus, functional blocks of the router that don't need to differentiate between metadata related to multicast packets and metadata related to unicast packets do not have to be changed to employ embodiments of the present invention.

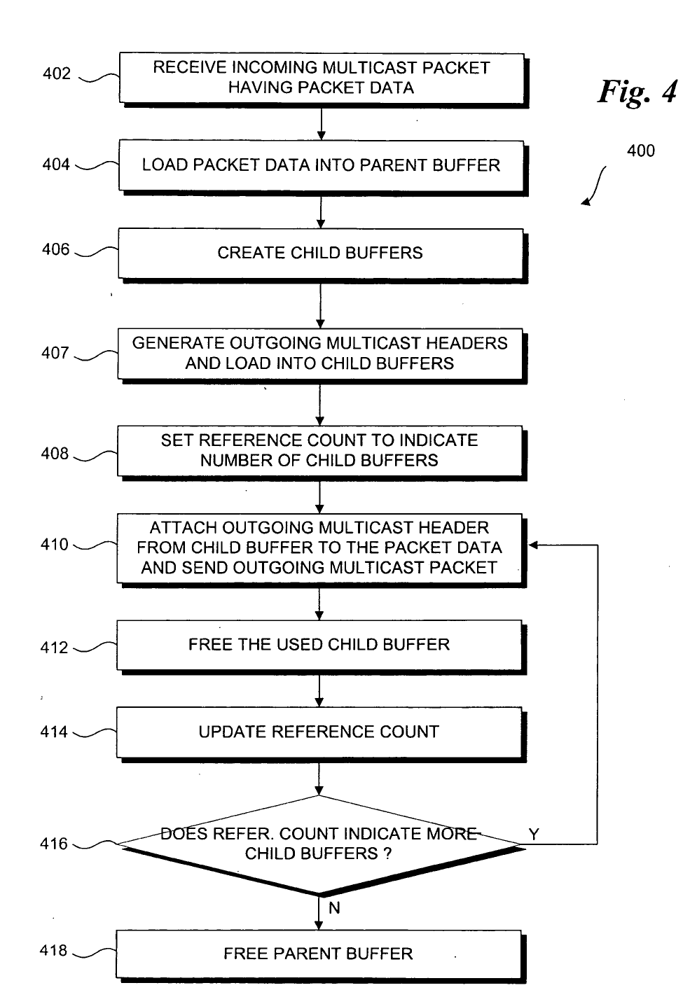

Referring to FIG. 4, a flowchart 400 shows an embodiment to provide multicast support on a network device. Beginning in a block 402, the network device, such as a router, receives an incoming multicast packet having packet data and an incoming multicast header. The router is to forward the incoming multicast packet onto the recipients within the multicast group. Continuing in a block 404, the packet data is loaded into a parent buffer of the network device. In one embodiment, the parent buffer is managed by a receiver of the network device. As depicted in a block 406, child buffers are created. In one embodiment, the number of child buffers corresponds to the number of different paths the multicast packet is to be forwarded onto. In one embodiment, the child buffers are managed by a copy block of the network device.

Continuing to a block 407, the outgoing multicast headers are generated based on the incoming multicast header and loaded into the child buffers. Each child buffer is loaded with an outgoing multicast header.

The logic continues to a block 408 that shows a reference count being set to indicate the number of child buffers. The reference count will be used by the network device to manage the release of child buffers after their respective outgoing multicast headers have been used in constructing an outgoing multicast packet.

In a block 410, an outgoing multicast header from a child buffer is attached to the packet data to create an outgoing multicast packet and the outgoing multicast packet is sent from the network device. In one embodiment, a packet processing unit of the router modifies the incoming multicast header to generate the outgoing multicast headers. The copy block may make multiple copies of the incoming multicast header from the incoming packet. The packet processing unit then processes each of the individual copies of the incoming multicast header and may modify each of theses copies differently to produce the outgoing multicast headers.

Proceeding to a block 412, the child buffer that contained the header that was sent in the multicast packet is freed. Thus, the memory space that was occupied by this child buffer may now be allocated to other needs by the network device. Continuing to a block 414, the reference count is updated to reflect the reduction in the number of child buffers pointing to the parent buffer.

The logic proceeds to a decision block 416 to determine if the reference count indicates there are more child buffers pointing to the parent buffer. If the answer is yes, then the logic proceeds to block 410 to create another outgoing multicast packet from the remaining headers. If the answer is no, then the logic proceeds to a block 418. Block 418 shows that the parent buffer is freed. The packet data no longer needs to be maintained in memory of the network device because all the outgoing multicast packets have been forwarded to their destinations.

It will be understood that according to embodiments of the present invention, no copying of packet data is needed to forward multicast packets. Separate copies of the same packet data are not created and stored in DRAM of a router. Instead, one copy of the packet data is put in DRAM and child buffers point to the actual packet data. The same packet data stored in DRAM is transmitted several times on different output interfaces of the router. Thus, multicast packets are forwarded without making numerous copies of the packet data in memory. This prevents a slow down in packet processing because of the limits of memory bandwidth.

Referring to FIG. 1, router 104 does not have to make three copies of the packet data to forward multicast packets to routers 106, 108, and 110. The router 104 maintains a single copy of the packet data in a parent buffer. Outgoing multicast headers from child buffers are attached to the packet data and transmitted on output ports leading to routers 106, 108, and 110. Thus, only one copy of the packet data is stored in memory instead of three.

Further, most of the functional blocks of a network device do not have to be re-coded to support embodiments of the present invention. Most of the packet processing blocks do not discern between unicast and multicast transmissions. Using a metadata structure for multicast packets that is similar to a unicast metadata structure enables a network device to handle unicast and multicast packets the same. Also, since components of the network device do not discriminate between multicast and unicast communications, there is little degradation in performance in handling unicast traffic by the network device. Minimal changes to the network device may include modifying the transmitter to manage the reference count and adding a copy block.

It will be understood that the transmitter 210 may have to be changed to support the multicast support scheme described herein. In one embodiment, the transmitter reads the reference count 222 from the parent meta-data 330 and decrements the reference count 222 after a child buffer has been freed. Usually, the child buffer will be freed once its header has been transmitted in an outgoing multicast packet. The parent buffer 302 will be freed when the reference count 222 indicates there are no more child buffers remaining. The reading of the reference count 222 adds an extra dependency on the packet transmit code. However, since unicast and multicast packet information is stored in local memory awaiting transmission, the reading and checking of the reference count 222 can be hidden in the existing packet processing phases. This ensures minimal changes to the code of transmitter 210 and enables the transmitter 210 to meet the packet processing line-rate.

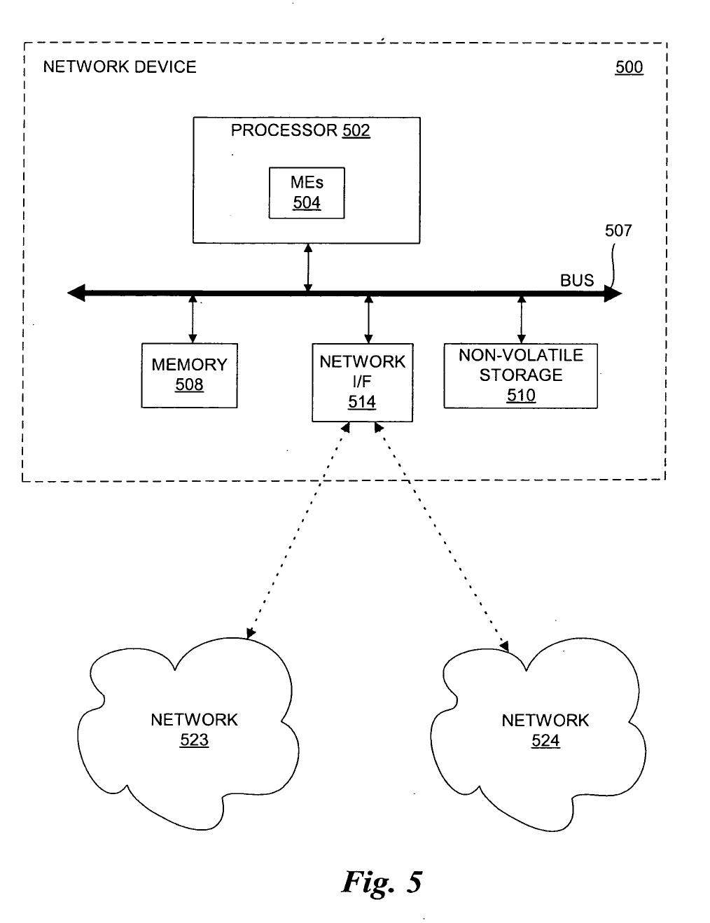

FIG. 5 is an illustration of one embodiment of an example network device 500 on which embodiments of the present invention may be implemented. In one embodiment, network device 500 is a router. Network device 500 includes a processor 502 coupled to a bus 507. Memory 508, non-volatile storage 510, and network interface 514 are also coupled to bus 507. The network device 500 interfaces to networks through the network interface 514. Generally, the network device 500 is used to interconnect networks. As shown in FIG. 5, network device 500 interconnects a network 523 and a network 524. Such networks include a local area network (LAN), wide area network (WAN), or the Internet. Networks 523 and 524 may include at least one host device (not shown) such as a personal computer, a server, a mainframe computer, or the like. The network device can interconnect networks that use different technologies, including different media, physical addressing schemes, and frame formats. While FIG. 5 shows the network device 500 connecting two networks 523 and 524, it will be understood that network device 500 may be connected to more or less than two networks. Network device 500 may operate with Internet Protocol version 4 (IPv4), Internet Protocol version 6 (IPv6), or the like.

Processor 502 may be a network processor including, but not limited to, an Intel® Corporation IXP (Internet eXchange Processor) family processor such as the IXP 4xx, IXP 12xx, IXP24xx, IXP28xx, or the like. In one embodiment, processor 502 includes a plurality of micro-engines (MEs) 504 operating in parallel, each micro-engine managing a plurality of threads for packet processing. In one embodiment of a micro-engine, code to execute on the micro-engine is stored in volatile memory within the micro-engine. In another embodiment, the code is downloaded from a network to a micro-engine when the router is turned on.

Memory 508 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. A typical network device will usually include at least a processor 502, memory 508, and a bus 507 coupling memory 508 to processor 502.

The network device 500 also includes non-volatile storage 510 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), or the like. It is appreciated that instructions (e.g., software, firmware, etc.) may reside in memory 508, non-volatile storage 510 or may be transmitted or received via network interface 514.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., a read only memory (ROM), a random access memory (RAM), a magnetic disk storage media, an optical storage media, a flash memory device, etc.). In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method, comprising:
receiving an incoming multicast packet at a network device, the incoming multicast packet comprising an incoming multicast header and packet data;
storing the packet data at the network device;
generating a plurality of outgoing multicast headers based on the incoming multicast header; and
attaching each outgoing multicast header of the plurality of outgoing multicast headers to the packet data to create a plurality of outgoing multicast packets without making multiple copies of the packet data.

2. The method of claim 1, further comprising storing the packet data in a parent buffer of the network device.

3. The method of claim 2 wherein a parent metadata is associated with the parent buffer, the parent metadata to include a description of contents of the parent buffer.

4. The method of claim 1, further comprising:
creating a plurality of child buffers; and
loading the plurality of outgoing multicast headers into the plurality of child buffers.

5. The method of claim 4 wherein a plurality of child metadata are associated with the plurality of child buffers, each child metadata to describe the content of its respective associated child buffer.

6. The method of claim 5 wherein the plurality of child buffers and the plurality of child metadata are created by a copy block of the network device.

7. The method of claim 4, further comprising creating a reference count indicating the number of child buffers of the plurality of child buffers pointing to the parent buffer.

8. The method of claim 4, further comprising freeing a child buffer of the plurality of child buffers after an outgoing multicast packet of the plurality of outgoing multicast packets including the outgoing multicast header from the child buffer is forwarded by the network device.

9. The method of claim 8, further comprising updating the reference count to indicate the child buffer has been freed.

10. The method of claim 7, further comprising freeing the parent buffer when the reference count indicates there are no more child buffers.

11. The method of claim 1, further comprising receiving an incoming unicast packet by the network device, the incoming unicast packet to be processed similarly as the incoming multicast packet.

12. An article of manufacture, comprising:
a machine-readable medium including a plurality of instructions which when executed perform operations comprising:
receiving an incoming multicast packet at a router, the incoming multicast packet comprising packet data;
storing the packet data in a parent buffer of the router;
generating a plurality of outgoing multicast headers;
storing the plurality of outgoing multicast headers in a corresponding plurality of child buffers; and
repeatedly attaching an outgoing multicast header of the plurality of outgoing multicast headers to the packet data to create an outgoing multicast packet and transmitting the outgoing multicast packet until each outgoing multicast header of the plurality of outgoing multicast headers has been used.

13. The article of manufacture of claim 12 wherein the parent buffer is managed by a receiver of the router.

14. The article of manufacture of claim 12 wherein the plurality of child buffers are created by a copy block of the router.

15. The article of manufacture of claim 12 wherein execution of the plurality of instructions further perform operations comprising freeing a child buffer after the outgoing multicast header stored in the child buffer is transmitted in an outgoing multicast packet.

16. The article of manufacture of claim 15 wherein execution of the plurality of instructions further perform operations comprising updating a reference count to indicate the number of child buffers remaining.

17. The article of manufacture of claim 16 wherein the reference count is updated by a transmitter of the router.

18. The article of manufacture of claim 12 wherein execution of the plurality of instructions further perform operations comprising freeing the parent buffer after all outgoing multicast headers of the plurality of outgoing multicast headers have been used.

19. The article of manufacture of claim 12 wherein execution of the plurality of instructions further perform operations comprising receiving an incoming unicast packet at the router, the incoming unicast packet to be processed similarly as the incoming multicast packet.

20. A network device, comprising:
a receiver to receive an incoming multicast packet comprising packet data;
a first memory unit coupled to the receiver, the first memory unit to store the packet data;
a packet processing unit operatively coupled to the receiver, the packet processing unit to process unicast and multicast packets passing through the router;
a copy block coupled to the packet processing unit, the copy block to manage a plurality of outgoing multicast headers stored in a second memory unit of the network device; and
a transmitter operatively coupled to the packet processing unit.

21. The network device of claim 20 wherein the packet processing unit to attach an outgoing multicast header from the plurality of outgoing multicast headers to the packet data to create an outgoing multicast packet.

22. The network device of claim 21 wherein the transmitter to free a portion of the second memory unit storing the outgoing multicast header after the outgoing multicast packet is transmitted.

23. The network device of claim 22 wherein the transmitter to update a reference count after the outgoing multicast header is transmitted, the reference count indicating the number of outgoing multicast headers of the plurality of outgoing multicast headers to be transmitted in an outgoing multicast packet.

24. The network device of claim 20 wherein the copy block to generate the plurality of outgoing multicast headers based on an incoming multicast header of the incoming multicast packet.

25. The network device of claim 20 wherein the network device to process an incoming unicast packet along the same processing pipeline as the incoming multicast packet.

26. A system, comprising:
a network including a source host of a multicast group; and
a router communicatively coupled to the network, the router comprising:
a processor; and
a storage device operatively coupled to the processor, the storage device including a plurality of instructions which when executed by the processor perform operations comprising:
receiving an incoming multicast packet from the source host via the network, the incoming multicast packet comprising an incoming multicast header and packet data; and
storing the packet data in a memory device operatively coupled to the processor;
generating a plurality of outgoing multicast headers based on the incoming multicast header; and
attaching each outgoing multicast header of the plurality of outgoing multicast headers to the packet data to create a plurality of outgoing multicast packets without making multiple copies of the packet data.

27. The system of claim 26 wherein execution of the plurality of instructions further perform operations comprising forwarding the plurality of outgoing multicast packets.

28. The system of claim 26, further comprising a second network to receive an outgoing multicast packet of the plurality of outgoing multicast packets, the second network including a recipient host of the multicast group.
